(19) United States
(12) Patent Application Publication
(10) Pub. No.: US 2025/0322006 A1
(43) Pub. Date: Oct. 16, 2025

(54) Automated Tool For Determining And Providing Information About Dwellings Using Heterogenous Search Strategies

(71) Applicant: MFTB Holdco, Inc., Seattle, WA (US)

(72) Inventors: Hubert Vijay Arokiasamy, Union City, CA (US); Dushyant R. Maheshwary, Seattle, WA (US); Piali Syam, Newark, CA (US); Alexey Serba, Pleasanton, CA (US); Sandesh Satish, Seattle, WA (US); Ashwani Kapoor, Union City, CA (US); Rajendra Waman Shioramwar, San Ramon, CA (US)

(21) Appl. No.: 18/632,217

(22) Filed: Apr. 10, 2024

(51) Int. Cl. G06F 16/387; G06F 40/30

(52) U.S. Cl. CPC G06F 16/387; G06F 40/30

(57) ABSTRACT

Techniques are described for performing automated operations related to determining and providing information about dwellings within geographical regions specific to indicated locations, such as within an indeterminate distance from an indicated point-of-interest (POI) location by determining and using individualized geographical search regions specific to each POI location. In some situations, for each of a plurality of POI locations, a geographical region specific to that POI location is predetermined in an individualized manner for that POI location using attribute(s) of that POI location, to represent a geographical region for that POI location considered to be nearby that POI location, and then using such predefined POI-specific nearby geographical regions when responding to a later received search query that specifies multiple search criteria using a sequence of multiple free-form natural language terms that indicate such a POI location, such as in combination with other search criteria.

### TECHNICAL FIELD

The following disclosure relates generally to techniques for automatically determining and providing information about dwellings using heterogeneous search strategies, such as to automatically respond to a free-form natural language search query for information about dwellings by separating the search query into multiple segments and using a combination of multiple search strategies for at least some of the multiple segments.

### BACKGROUND

An abundance of information is available to users on a wide variety of topics from a variety of sources. For example, portions of the World Wide Web (“the Web”) are akin to an electronic library of documents and other data resources distributed over the Internet, with billions of documents available, including groups of documents directed to various specific topic areas (e.g., buildings of various types). In addition, various other information is available via other communication mediums. However, existing search engines and other techniques for identifying information of interest suffer from various problems. Non-exclusive examples include a difficulty in understanding natural language requests, difficulty in providing accurate information that is specific to a particular topic of interest, difficulty in limiting information requests to approved topics, etc.

### BRIEF DESCRIPTION OF THE DRAWINGS

FIGS. 1A-1B are network diagrams illustrating an example system for performing described techniques, including automatically responding to a free-form natural language request for information about dwellings by using heterogeneous search strategies.

FIG. 1C illustrates examples of non-exclusive types of building description information.

FIGS. 2A-2E illustrate examples of performing described techniques, including automatically responding to a free-form natural language request for information about dwellings by using heterogeneous search strategies.

FIG. 3 is a block diagram illustrating an example of a computing system for use in performing described techniques, including automatically responding to a free-form natural language request for information about dwellings by using heterogeneous search strategies.

FIG. 4 illustrates a flow diagram of an example embodiment of an Automated Dwelling Information Retrieval Using Heterogeneous Search Strategies (“ADIRUHSS”) system routine.

FIG. 5 illustrates a flow diagram of an example embodiment of an ADIRUHSS Candidate Dwelling Evaluator/Selector component routine.

FIG. 6 illustrates a flow diagram of an example embodiment of a client device routine.

### DETAILED DESCRIPTION

The present disclosure describes techniques for using computing devices to perform automated operations involving automatically determining and providing information about dwellings using heterogeneous search strategies, such as in at least some embodiments to automatically respond to a free-form natural language search request for information about dwellings by separating the search query into multiple segments and using a combination of multiple search strategies for at least some of the multiple segments to determine and provide corresponding search results. In at least some embodiments, the described techniques include training a machine learning (“ML”) model to encode semantic information about dwellings into a vector-based embedding (also referred to herein as a “vector embedding”), and then using the trained ML model to generate vector embeddings for some or all dwellings in one or more geographical areas, such as to encode data about a dwelling from a textual narrative description of the dwelling as well as dwelling information in one or more other forms (e.g., a plurality of keyword-value pairs). After the generation of the dwelling vector embeddings, the described techniques may include receiving a search query that specifies multiple search criteria using a sequence of multiple free-form natural language terms, segmenting the multiple free-form natural language terms into multiple segments that each corresponds to one of the search criteria, and identifying a group of candidate dwellings to further consider (e.g., all dwellings of an indicated dwelling type that are in an indicated geographical area and/or are within an indicated distance from a point-of-interest location). The described techniques further include selecting different parts of the search query to handle differently, including to apply a combination of multiple different search strategies to different parts of the search query to identify different groups of the candidate dwellings that match the different parts of the search query, and with one of the search strategies based on using vector embeddings—the vector embedding-based search may include generating a vector embedding to encode sematic information for some or all of the query segments, measuring differences between the query vector embedding and the generated dwelling vector embeddings of the candidate dwellings, and selecting candidate dwellings based on the differences (e.g., candidate dwellings with measured differences below a defined threshold). Candidate dwellings identified using the multiple search strategies may then be combined to form search results with matching target dwellings in various manners in various embodiments, with information about matching target dwelling(s) then further used. Additional details are included below regarding automatically responding to a free-form natural language search request for information about dwellings using a combination of multiple search strategies, and some or all of the techniques described herein may, in at least some embodiments, be performed via automated operations of an Automated Dwelling Information Retrieval Using Heterogeneous Search Strategies (“ADIRUHSS”) system, as discussed further below.

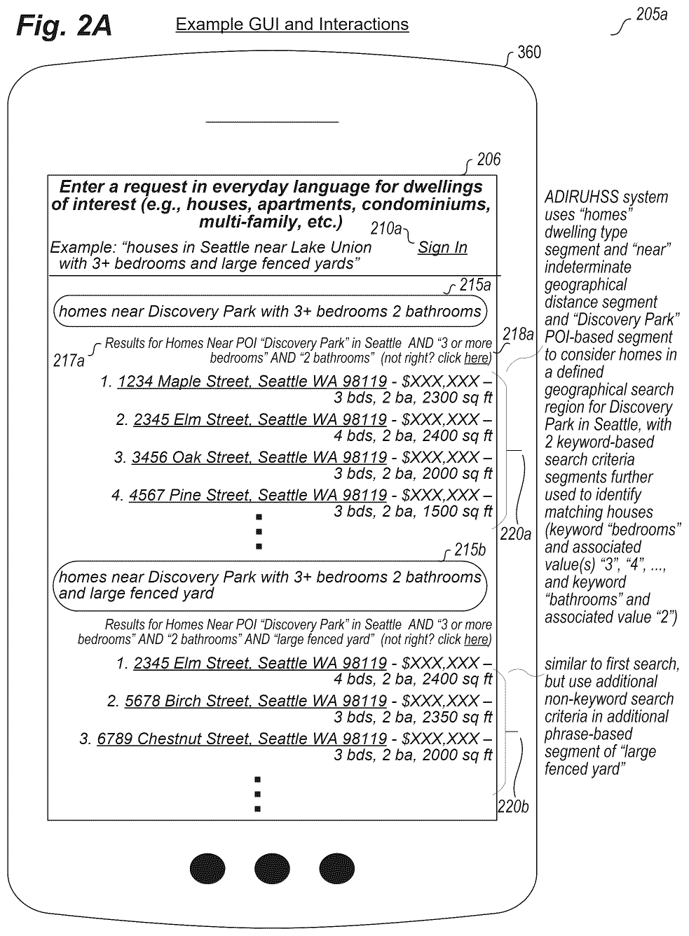

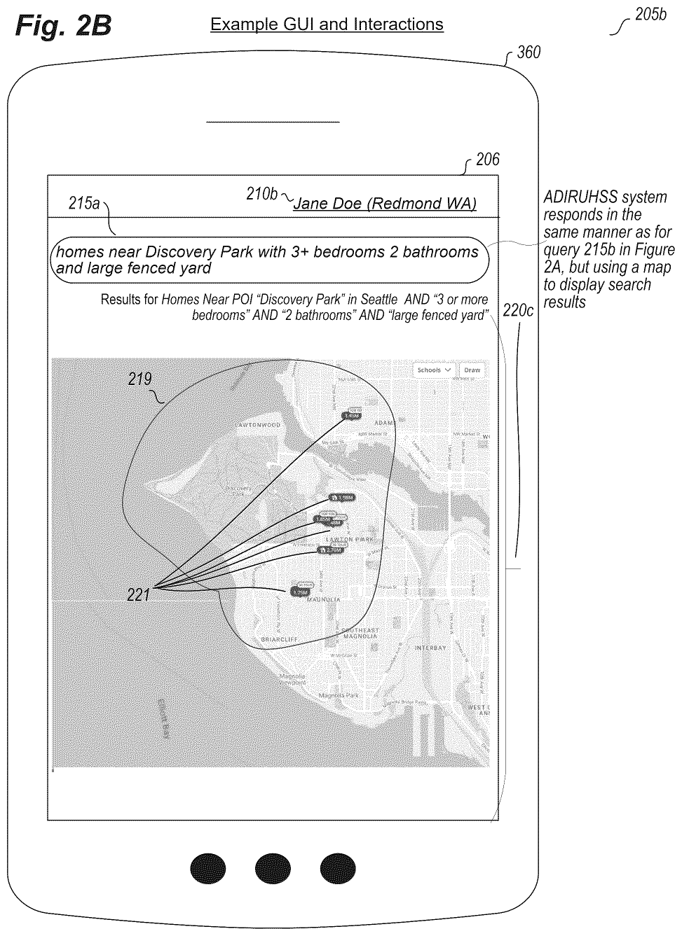

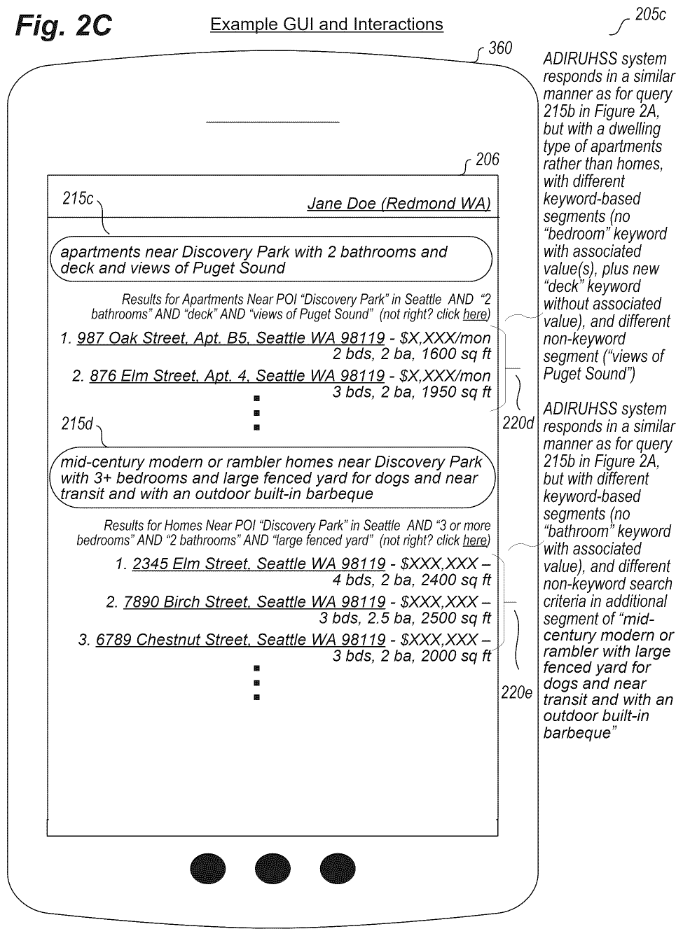

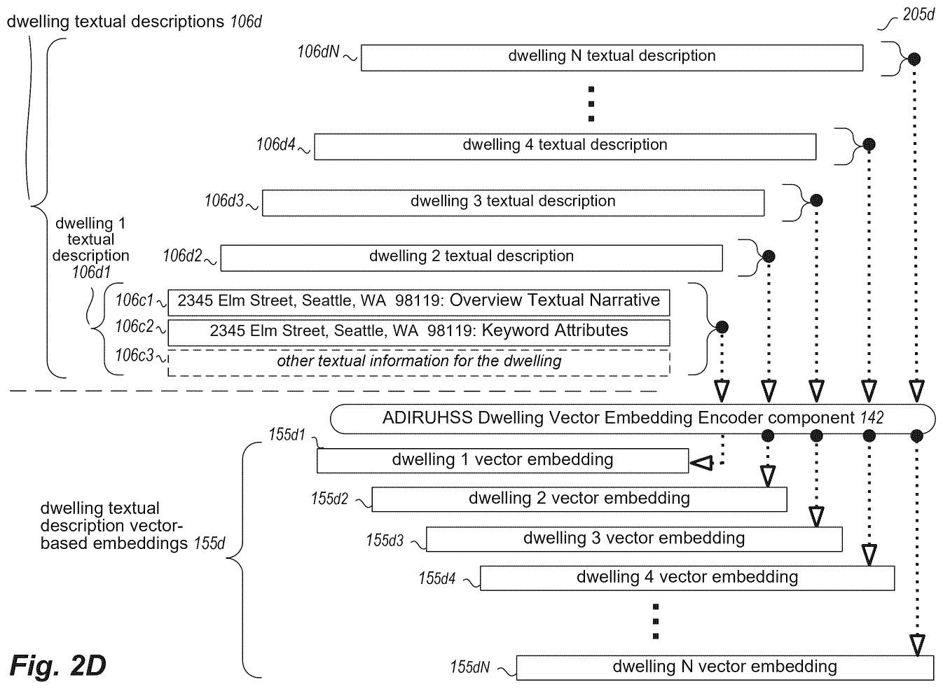

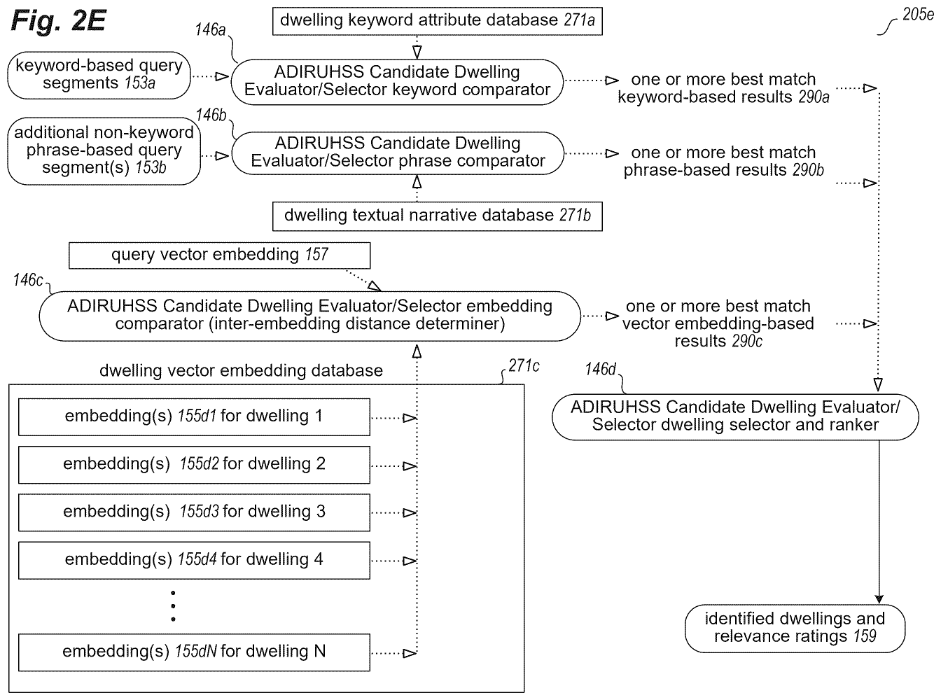

As noted above, the described techniques may include segmenting multiple free-form natural language terms of a received query into multiple segments that each corresponds to a different search criteria, such as to include segments that each indicates one of the following: a type of dwelling (e.g., houses, homes, apartments, condominiums, etc.); a geographical area (e.g., cities, counties, states, neighborhoods, etc.); a point-of-interest (POI) location (e.g., particular parks, beaches, lakes, businesses, etc.), optionally with a specified distance radius or indeterminate distance indication (“nearby”, “close to”, etc.); a dwelling-related attribute (e.g., number of bedrooms and/or bathrooms, square footage, property size, dwelling style, price, etc.) and optionally one or more associated attribute values; a neighborhood and/or surroundings attribute (e.g., close to a body of water, a kid-friendly area, etc.) and optionally one or more associated attribute values; etc., as well as one or more conjunctive (e.g., “and”) and/or disjunctive (e.g., “or”) terms to connect two specified search criteria—in other embodiments, some such criteria (e.g., geographical location, POI location, dwelling type, etc.) may be determined in manners other than being included in the search query, such as to be associated with the user who submits the search query (e.g., based on the user's location, preferences, prior search interactions, etc.) and/or based on a search interface being used (e.g., one specific to houses or apartments). The described techniques may further include selecting different parts of a received search query to handle differently, such as to identify any first segments with dwelling-related attributes having a keyword term matching a group of predefined keywords (e.g., those used in a group of standardized dwelling keyword-value pairs, such as on typical MLS, or multiple listing service, forms), to identify any second segments of other predetermined types (e.g., geographical area; POI location; dwelling type; etc.), and to identify any third segments that are not of the other predetermined types and do not include any of the predefined keywords (e.g., “close to a park”, “with good schools”, “mid-century modern or modern farmhouse”, etc.), and to apply different search strategies to different parts of the received search query. For example, the described techniques may further use the identified second segments of other predetermined types to limit the candidate dwellings that are considered as possible matches, such as to limit the candidate dwellings to those in a specified geographical area, to those within an indicated distance of a POI location and/or to those of an indicated dwelling type, or may otherwise determine a group of candidate dwellings to consider in other manners (e.g., using similar types of information determined other than as part of the search query). The described techniques may further use the identified first segments each having a keyword term and optionally one or more associated values to perform a keyword-based search to match keywords included in building descriptions of a group of first dwellings identified from the candidate dwellings (e.g., using a plurality of keyword-value pairs in the building descriptions), with any included associated values being further matched to corresponding values for the first dwellings' attributes (e.g., “3 or more bedrooms” to match dwellings' keyword-value pairs such as “bedrooms: 3”, “bedrooms: 4”, “bedrooms: 5”, etc.)—in at least some embodiments and situations, such searching may include using an inverted index-based search. The described techniques may further optionally use the identified third segments to perform a phrase-based exact or near-exact search to match a phrase in a third segment to corresponding phrases included in narrative building descriptions of a group of second dwellings identified from the candidate dwellings, such as to perform an exact match, or to identify near-exact matches by using one or more of synonyms, stemming and lemmatization to substitute alternative terms in the third-segment phrase. Additional details are included below regarding analyzing a received search query and using different parts of the search query in different manners, including with respect to examples of FIGS. 2A-2E.

In addition, the described techniques may further include identifying a group of third dwellings identified from the candidate dwellings using a vector embedding-based search that measures differences between a generated query vector embedding and generated dwelling vector embeddings of the candidate dwellings, and selecting third dwellings based on the differences (e.g., candidate dwellings with measured differences below a defined threshold). As noted above, the query vector embedding and dwelling vector embeddings are generated in at least some embodiments using a ML model trained to encode semantic relationships and other semantic information about dwellings in a vector-based embedding, such as to convert high-dimensional data into low-dimensional vectors that preserves the underlying structure and content of the data-due to such preservation of the structure and content of the data, two vector embeddings that encode similar content are themselves similar, such that the difference between two such vector embeddings is small (e.g., as measured using an inter-vector distance). The ML model may have various forms in various embodiments, and may be generated and trained in various manners in various embodiments. As non-exclusive examples, the ML model may be a word-embedding model or text-embedding model that is generated using at least one of General Text Embeddings (GTE) with multi-stage contrastive learning, BERT (Bidirectional Encoder Representations from Transformers), Word2Vec (e.g., using continuous bag of words, or CBOW, and/or Skip-gram), principal component analysis (PCA), singular value decomposition (SVD), etc. The training of the ML model may include, for example, using positive examples that each includes two or more first real estate phrases that are semantically similar, and using negative examples that each includes two or more second real estate phrases that are not semantically similar. As noted above, the query vector embedding may encode content from some or all of the query, such as at least the phrase-based third segment(s) that are not of the other predetermined types (e.g., geographical area, POI location, dwelling type, etc.) and do not include any of the predefined keywords, and optionally some or all of rest of the query (e.g., the keyword-based first segments and/or the other predetermined type second segments)—in at least some embodiments and situations, the query vector embedding may be further personalized to a user who submitted the query by further encoding content in the query vector embedding that is specific to the user (e.g., preferences, prior search interactions, etc.) in addition to content from the query. In addition, each dwelling vector embedding may encode content from at least a textual building description of a respective dwelling, such as a textual narrative description and a plurality of keyword-value pairs—in at least some embodiments and situations, the content encoded in the vector embedding for at least some dwellings includes additional information of one or more types and from one or more sources (e.g., further textual information from external sources, such as public property records, tax records, neighborhood crime reports, neighborhood feature descriptions, etc.; textual information generated from analysis of images of a dwelling interior and/or exterior; etc.). Additional details are included below regarding generating and using vector embeddings and generating and training a corresponding ML model, including with respect to the examples of FIGS. 2A-2E.

In at least some embodiments and situations, each of the multiple search strategies are performed independently for a given search query and the results of the multiple searches are subsequently combined to identify zero or more target dwellings that satisfy the multiple search criteria specified for the search query, while in other embodiments and situations the multiple search strategies may be employed in other manners (e.g., to first identify candidate dwellings using information of predefined types, such as geographical area and/or POI location and/or dwelling type; to next identify a first subset of the candidate dwellings using one of the search strategies, such as first dwellings that satisfy any keyword-based first segments; to next identify a further second subset of the candidate dwellings in the first subset, such as second dwellings that further satisfy any phrase-based third segments; to next identify a further third subset of the candidate dwellings in the second subset, such as third dwellings that further satisfy any vector embedding-based searching; etc.). When the results of the multiple search strategies are combined after the multiple searches are independently performed, the results may be combined to determine zero or more target dwellings that satisfy the search query in various manners in various embodiments, such as one or more of the following: to select all dwellings that appear in all of the searches and satisfy all of the multiple criteria as the target dwellings, and to optionally use information about degrees of match to rank or otherwise order the search results (e.g., using a distance or other difference from the vector embedding-based search, using a degree of match for the phrase-based search, etc.); to select dwellings that appear in some of the searches (e.g., the keyword-based search using any keyword-based first segments and the vector embedding-based search) as the target dwellings and to optionally use information from other search(es) (e.g., the phrase-based search) and/or other information about degrees of match to rank or otherwise order the search results; etc. After such filtering and/or ranking, a subset of one or more of the remaining identified dwellings may further be selected in some embodiments (e.g., a top Y, where Y is a defined quantity threshold, such as 1 or 10 or 100; a top Y %, where Y is a defined percentage threshold, such as 1% or 5% or 10%; etc.), while in other embodiments all remaining identified dwellings may be selected—if multiple such identified dwellings are selected, they may be further provided in a ranked manner, such as with a highest-ranked dwelling first. In other embodiments and situations in which results are provided in a manner overlaid on or otherwise in association with a map, the indicated dwellings may not be ranked, or rankings may be indicated using visual cues for respective dwellings (e.g., using sizes, colors, highlighting, flashing, etc.). Additional details are included below regarding generating search results to a received search query that include identified target dwellings, including with respect to the examples of FIGS. 2A-2E.

The identified target dwelling(s) may be further used in various manners in various embodiments, such as to be presented or otherwise provided as search results (e.g., as a list, optionally rank-ordered; overlaid on a map; etc.). Responsive information for the query that includes the one or more identified dwellings may further be provided in various manners in various embodiments, such as in a GUI (graphical user interface) displayed to a user who submitted the query via the GUI. In addition, it will be appreciated that various types of information may be provided for an identified dwelling, such as images, textual descriptions, 3D models and other floor plans, prices, statistical data (e.g., square feet, quantity of bedrooms and bathrooms, etc.), videos, comments and other user-generated data, etc., that types of information may be selected to be provided in various manners (e.g., based on instructions received in the search query, using user preferences, using defaults unless otherwise specified, etc.), and that the GUI may provide functionality to enable a user to obtain further information about one or more dwellings selected by the user. Additional details are included below regarding using search results to a received search query that include identified target dwellings, including with respect to the examples of FIGS. 2A-2E.

The described automated techniques provide various benefits in various embodiments, including to significantly improve the identification and use of responsive information to specified queries for information about dwellings in indicated locations, including queries specified in a natural language format, and such as to more accurately determine matching dwellings by using a combination of multiple heterogeneous search strategies on different portions of the search query. Such automated techniques also allow such responsive answer information to be generated much more quickly and efficiently than previously existing techniques (e.g., using less storage and/or memory and/or computing cycles) and with greater accuracy, based at least in part on using the described techniques, including by defining and using dwelling vector embeddings that encode semantic information from building descriptions of respective dwellings and matching a query vector embedding to such dwelling vector embeddings, etc. In addition, in some embodiments the described techniques may be used to provide an improved GUI in which a user may more accurately and quickly obtain information, including in response to an explicit request (e.g., in the form of a natural language query), as part of providing personalized information to the user, etc. Various other benefits are also provided by the described techniques, some of which are further described elsewhere herein.

As noted above, the automated operations of the ADIRUHSS system in at least some embodiments include, for a received query using multiple free-form natural language terms to specify multiple search criteria, segmenting the terms in the received query into one or more segments each corresponding to an indicated search criterion. Such segmenting of the sequence of term(s) may be performed in various manners in various embodiments, such as by identifying matches in one or more dictionaries (e.g., general-purpose dictionaries, dictionaries of POI location names, dictionaries of geographical area names, etc.), lists of predefined keywords, lists of dwelling types, or other lists of word/phrase breaks, including in some embodiments and situations by considering each combination of singleton terms and two or more adjacent terms to determine if they match POI locations or geographical areas (e.g., for a sequence of terms such as “Space Needle Seattle”, considering alternative name-based designations of “Space”, “Needle”, “Seattle”, “Space Needle”, “Needle Seattle”, and “Space Needle Seattle”, and concluding that “Space” is grouped with “Needle” to identify a POI location name, leaving the name-based designation of “Seattle” to identify a surrounding geographical area that together uniquely identify the POI location, such as to differentiate the Space Needle in Seattle from other space needles in other geographical areas), etc. In some embodiments, each combination of terms is treated as a separate segment (e.g., for a sequence of terms such as “Stamford New York”, using all of “Stamford”, “New”, “York”, “Stamford New”, “New York” and “Stamford New York” as separate segments), or search queries may be parsed without using such segments. In addition, in some embodiments and situations, the received query may, in addition to the multiple segments each corresponding to a geographical area or a POI location, include one or more additional segments for one or more additional search criteria of one or more types, such as one or more of the following: dwelling-type designations (e.g., ‘apartment’, ‘single family house’, ‘condominium’, etc.); POI categories (e.g., “beaches”, “parks”, “schools”, “hospitals”, “lakes”, etc.); indeterminate distance indications that are associated with one or more POI locations and/or POI categories (e.g., “nearby” or analogous terms such as “near”, “by”, “around”, “at”, “close to”, “adjacent”, etc.; a travel-based distance measure with an indicated travel type, such as walking or bicycling or scootering or driving or bus or train or light rail or mass transit; etc., and an associated amount of travel time that is specified or otherwise determined); non-location-related search filters or other search criteria, such as search criteria related to dwelling attributes (e.g., minimum and/or maximum and/or target price, number of bathrooms, number of bedrooms, etc.), etc. In some embodiments and situations, some search criteria such as geographical area and/or dwelling type and/or indeterminate distance and/or other dwelling-related attributes may be automatically determined for use with the search query (e.g., inferred, selected as a default, etc.), optionally based on information specific to a user who submitted the search query and/or a current context (e.g., as part of an ongoing search interaction session by using previously specified details).

In addition, the automated operations of the ADIRUHSS system in at least some embodiments include determining, for each of a plurality of POI locations in one or more geographical areas, a geographical region specific to that POI location in an individualized manner for that POI location, such as to represent a geographical region around or otherwise for that POI location that includes additional locations (e.g., dwellings) considered to be nearby that POI location. In at least some embodiments, the determination of such a POI-specific nearby geographical region for a particular POI location is based on one or more attributes of that POI location, such as one or more of the following non-exclusive list: a category of the POI location (e.g., beach, lake, school, park, hospital, etc.), such as to have different defined distances associated with each POI category that represent locations ‘near’ a POI location of that POI category; a type of the one or more geographical areas in which that POI location is located (e.g., urban, suburban, rural, etc.), such as to have different defined distances associated with each type of geographical area that represent locations ‘near’ a POI location in that type of geographical area; a shape of that POI location (e.g., a single GPS point location; a regular or irregular geometric two-dimensional or three-dimensional shape, such as circles or ovals or squares or rectangles for a regular two-dimensional geometric shape, and represented by a group of GPS point locations, such as for some or all of a boundary, or instead by a single GPS point location to represent such a shape, such as a center; a two-dimensional line or three-dimensional wall; etc.), such as to have different defined distances associated with each type of POI location shape that represent locations ‘near’ a POI location of that POI location shape; etc. In embodiments in which multiple POI location attributes are used to determine the size for a POI-specific nearby geographical region (also referred to at times herein as a “POI-specific geographical region”), the sizes associated with different such attributes may be combined in various manners in various embodiments, such as to use an average (e.g., a weighted average), a maximum, a minimum, etc. In addition, in some embodiments each of some or all POI locations may have multiple predefined POI-specific nearby geographical regions, such as to correspond to geographical regions that are ‘near’ that POI location for each of multiple travel types (e.g., walking, cycling, scootering, driving, bus, train, light rail, mass transit, etc.) and/or associated travel times (e.g., ‘within 5 minutes walking’, ‘within 10 minutes walking’, . . . , ‘within 5 minutes driving’, ‘within 10 minutes driving’, etc.), and/or that are ‘near’ that POI location for other factors (e.g., based on time-of-day, day-of-week, month, season, etc.). Furthermore, in some embodiments a POI-specific nearby geographical region for a POI location may be generated using a consistent defined size to encircle a boundary of that POI location's shape, while in other embodiments may be approximated in other manners (e.g., using a bounding box or bounding circle or other bounding shape), using different sizes for different portions of a boundary of that POI location, etc. In addition, in some embodiments a predefined POI-specific nearby geographical region for a POI location may be adjusted or otherwise modified for use with a particular search query, such as to reflect explicit or implicit preferences of a user who submitted the search query (e.g., to increase or decrease the geographical region boundaries for a user who has a more expansive or restrictive, respectively, conception of ‘nearby’ than average or typical).

As is also noted above, the automated operations of the ADIRUHSS system in at least some embodiments include managing received search queries that specify an indeterminate travel-based distance that includes at least a travel type and optionally a travel time—in cases in which a travel time is not indicated (e.g., “within walking distance of”), the ADIRUHSS system may select a travel time to use, such as specific to that travel type or instead the same for all travel types, based on information specific to the user who submitted the query, etc. The system may determine geographical distances associated with such a travel-based distance in various manners in various embodiments, such as to use geographical mapping/travel functionality to determine additional locations that are reachable from each of some or all GPS boundary locations associated with that POI location when using that travel type for that travel time, combine the additional locations that are determined for all of the POI location boundary, and determine a geographical region that includes all those additional locations (e.g., a smallest enclosing geographical region)—as one example, if using a travel type that corresponds to roads (e.g., walking, driving, bicycling, scooting, etc.), the determination of the additional locations may include moving outward from the POI location's boundaries along all roads in a widening search at each road junction until all possible locations reachable within that travel time for that travel type are identified. In other embodiments and situations, nearby geographical region boundaries specific to particular POI locations may be determined in other manners, such as to estimate one or more geographical distances corresponding to a given travel type and travel time, and to use such estimated geographical distance(s) in generating a POI-specific nearby geographical region for a particular POI location.

As is also noted above, the automated operations of the ADIRUHSS system in at least some embodiments include managing received search queries that specify a POI category, such as instead of or in addition to a particular POI location. In at least some embodiments, in order to manage such a specified POI category, one or more geographical areas associated with such a search query are determined, whether as specified in the search query or instead in other manners (e.g., specific to a user who submitted the search query, such as based on the user's location and/or other user preferences; based on a context of previous interactions during an interactive search session; etc.). After the one or more geographical areas are determined, each POI location within those one or more geographical areas of that POI category are identified, and may then each be used as an alternative POI location for the search, such as to individually use the predefined POI-specific nearby geographical region for each such POI location in order to identify potentially matching dwellings in that geographical region. In addition, in at least some embodiments and situations, the speed and/or accuracy of identifying dwellings that are within the POI-specific nearby geographical region for a particular POI location or for multiple such POI locations of a particular POI category is enhanced by predefining one or more attributes for each of some or all dwellings that associate that dwelling with the particular POI locations (if any) for which that dwelling falls within their respective predefined POI-specific nearby geographical regions, or that associate that dwelling with the particular POI categories (if any) for which that dwelling falls within the respective predefined POI-specific nearby geographical region for at least one particular POI location of that POI category—in such situations, the identification of a dwelling corresponding to a particular POI location or a particular POI category in a particular geographical area may include reviewing each dwelling in that geographical area to determine if it includes one or more such attributes that associate that dwelling with that particular POI location or POI category.

As is also noted above, the automated operations of the ADIRUHSS system in at least some embodiments include managing received search queries that specify one or more conjunctive and/or disjunctive terms that each connects two surrounding or otherwise adjacent search criteria (e.g., criteria A ‘and’ criteria B, criteria A ‘or’ criteria B, etc., in which A and B may be criterion such as POI location, POI category, dwelling type, geographical area, etc.). In at least some embodiments and situations, when a disjunctive term is used to connect two search criteria that each has one or more associated geographical regions (e.g., POI location 1 or POI location 2, POI location 1 or POI category 1, POI category 1 or POI category 2, etc.), an aggregate geographical region may be determined and used that is the set-based union of the two or more associated geographical regions for the two search criteria, such as an aggregate geographical region that includes multiple separated individual geographical regions within it, or instead an aggregate geographical region that is the superset of all of the individual geographical regions as well as the intervening areas between them. Similarly, in at least some embodiments and situations, when a conjunctive term is used to connect two search criteria that each has one or more associated geographical regions (e.g., POI location 1 and POI location 2, POI location 1 and POI category 1, POI category 1 and POI category 2, etc.), an aggregate geographical region is determined and used that is the set-based intersection of the two or more associated geographical regions for the two search criteria, such as an aggregate geographical region that includes only those locations belonging to all of the two or more associated geographical regions. In other embodiments, no such aggregate geographical region may be used, and instead the identification of dwellings may be performed for each of the two or more associated geographical regions for the two search criteria, with the resulting identified dwellings subsequently combined using the appropriate union or intersection for the corresponding disjunctive or conjunctive term, respectively. Other geographical constraints may similarly be specified and used, such as “within walking distance of” types of locations (e.g., highly rated restaurants), including with respect to conjunctive and disjunctive terms, and the determination of resulting geographical search regions may be similarly determined.

As is also noted above, the automated operations of the ADIRUHSS system in at least some embodiments include, after determining one or more predefined POI-specific nearby geographical regions to use for one or more POI locations to use as one or more geographical search regions for a user query, using the determined geographical search region(s) to determine and provide responsive information for the received query, such as information about one or more identified dwellings that are in the geographical search region(s) and thus proximate to the respective POI location(s). As one non-exclusive example, dwellings may be identified that are located in the determined geographical search region(s) and that further satisfy any additional specified non-location-related search filters or other search criteria (e.g., included in the received query). The identified dwellings may be further filtered and/or ranked in various manners, such as using one or more of the following: proximity to the POI location(s); one or more additional non-location-related search filters or other search criteria specified in the query; one or more user preferences of a user who submitted the received query, such as to improve the ranking of dwellings for closer matches with the user preference(s); etc. After such filtering and/or ranking, a subset of one or more of the remaining identified dwellings may further be selected in some embodiments (e.g., a top Y, where Y is a defined quantity threshold, such as 1 or 10 or 100; a top Y %, where Y is a defined percentage threshold, such as 1% or 5% or 10%; etc.), while in other embodiments all remaining identified dwellings may be selected—if multiple such identified dwellings are selected, they may be further provided in a ranked manner, such as with a highest-ranked dwelling first. In other embodiments and situations in which results are provided in a manner overlaid on or otherwise in association with a map, the indicated dwellings may not be ranked, or rankings may be indicated using visual cues for respective dwellings (e.g., using sizes, colors, highlighting, flashing, etc.). Responsive information for the query that includes the one or more identified dwellings may further be provided in various manners in various embodiments, such as in a GUI (graphical user interface) displayed to a user who submitted the query via the GUI. In addition, it will be appreciated that various types of information may be provided for an identified dwelling, such as images, textual descriptions, 3D models and other floor plans, prices, statistical data (e.g., square feet, quantity of bedrooms and bathrooms, etc.), videos, comments and other user-generated data, etc., that types of information may be selected to be provided in various manners (e.g., based on instructions received in the search query, using user preferences, using defaults unless otherwise specified, etc.), and that the GUI may provide functionality to enable a user to obtain further information about one or more dwellings selected by the user.

Additional details related to operations for receiving, analyzing and responding to search queries are included in U.S. Non-Provisional patent application Ser. No. 18/583,602, filed Feb. 21, 2024 and entitled “Automated Tool For Determining And Providing Building Information For Multiple Partially Described Proximate Geographical Regions”; in U.S. Provisional Patent Application No. 63/562,646, filed Mar. 7, 2024 and entitled “Automated Tool For Determining And Using User-Specific Predicted Attributes Of Dwellings That Users Will Later Occupy”; and in U.S. Provisional Patent Application No. 63/625,199, filed Jan. 25, 2024 and entitled “Automated Tool For Determining And Providing Information About Dwellings Within Geographical Regions That Are Determined Specific To Indicated Locations”; each of which is incorporated herein by reference in its entirety.

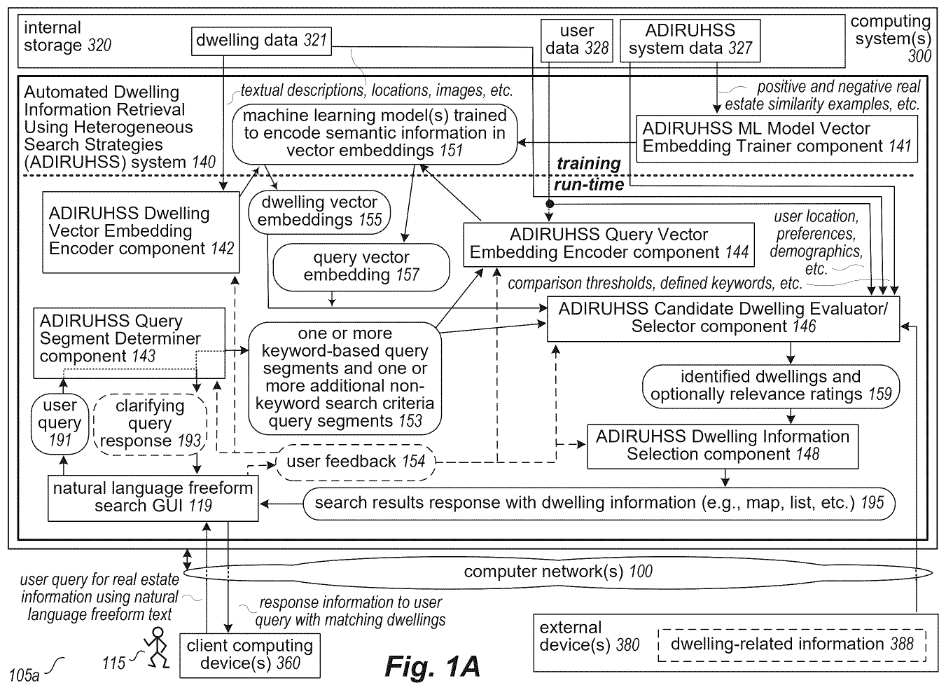

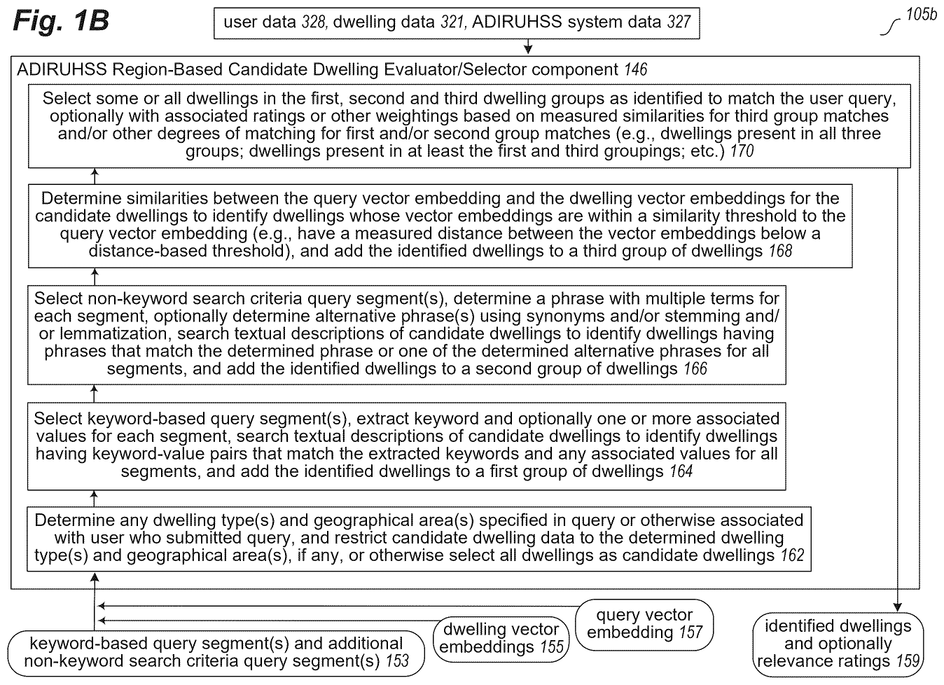

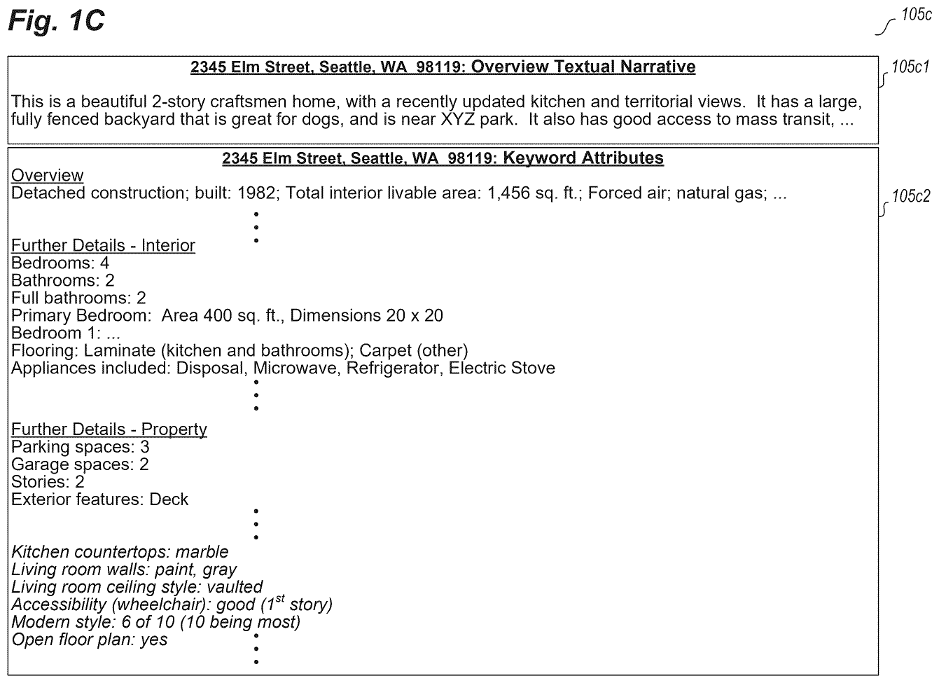

FIGS. 1A-1B are network diagrams illustrating an example system for performing described techniques, including automatically responding to a free-form natural language dwelling information request for information about dwellings by using heterogeneous search strategies.

In particular, FIG. 1A illustrates information 105a about an example embodiment of an ADIRUHSS system 140 executing on one or more computing systems 300, and interacting over one or more computer networks 100 with one or more client computing devices 360, such as to receive query requests from users 115 of the client computing devices for information about dwellings and to provide corresponding responses with requested dwelling information (e.g., as part of search results). In the illustrated embodiment, the computing systems 300 may store various information on storage 320 that is used by the ADIRUHSS system during operation (e.g., in one or more databases), including dwelling data 321 about dwellings in one or more geographical areas (e.g., in one or more countries, states, cities, etc., including information about textual building descriptions of the dwellings), user data 328 (e.g., user location; user preferences, such as expressly specified and/or implicitly determined from past activities of the user such as viewing or otherwise interacting with information about dwellings; prior and/or concurrent search interaction sessions with the user; etc.), and ADIRUHSS system data 327 (e.g., predefined keywords, search comparison thresholds, positive and negative training examples, information for use in segment determination such as word-break and/or phrase-break vocabularies, etc.). The ADIRUHSS system may further optionally retrieve and use other dwelling-related information 388 of one or more types stored externally to the computing systems 300 (e.g., from one or more public and/or private information sources), such as accessed over the one or more computer networks 100 from one or more external computing and/or storage devices 380, whether in addition to or instead of information stored on storage 320.

As one example of operations of the ADIRUHSS system 140, an ADIRUHSS ML Model Vector Embedding Trainer component 141 may obtain training data from the ADIRUHSS system data 327, and use the data to generate and/or train one or more machine learning (ML) models 151 to encode semantic information in vector embeddings, as discussed in greater detail elsewhere herein. The ADIRUHSS Dwelling Vector Embedding Encoder component 142 then uses the trained ML model(s) 151 to generate dwelling vector embeddings 155 for a plurality of dwellings in one or more geographical areas (e.g., all dwellings), such as by obtaining textual description information and optionally other information for the dwellings from dwelling data 321 and supplying it to the trained ML model(s) 151, optionally after manipulating and/or generating some of the information to be encoded in a resulting dwelling vector embedding for a dwelling (e.g., analyzing images of that dwelling to generate textual descriptions of them).

During further operations of the ADIRUHSS system 140, a particular user 115 of one of the client computing devices 360 may supply a query 191 about dwellings of interest to a natural language free-form input GUI 119 provided by the ADIRUHSS system. The GUI provides the user query to an ADIRUHSS Query Segment Determiner component 143, which analyzes the user query to attempt to identify segments within the query corresponding to multiple search criteria, such as to include at least one or more keyword-based query segments and one or more additional query segments that do not include any predefined keywords-if the component is unable to identify such segments, such as due to the received query lacking a correct format or types of information or due to having other problems, the component instead generates and returns a clarifying query response 193 to the GUI 119 to request further information from the user and/or to indicate an inability to respond. Otherwise, the component 142 forwards the determined query segments 153 to the ADIRUHSS Query Embedding Encoder component 144, which supplies some or all of the segments 153 to the trained ML model(s) 151 to generate a corresponding query vector embedding 157, with the component 144 optionally further manipulating and/or generating additional information to include in the information sent to the ML model(s) 151 that is encoded in the resulting query vector embedding 157 (e.g., to add information from user data 328 that is specific to the user 115 who submitted the user query 191 in order to personalize the resulting query vector embedding 157 to that user).

The generated query segments 153, query vector embedding 157 and dwelling vector embeddings 155 are then forwarded to the ADIRUHSS Candidate Dwelling Evaluator/Selector component 146, along with user data 328, dwelling data 321 and ADIRUHSS system data 327, and the component 146 proceeds to determine identified dwellings 159 that match the search criteria of the user query 191, optionally along with relevance ratings for some or all of the identified dwellings-one example of such a component 146 is discussed in further detail with respect to FIG. 1B. The identified dwellings 159 are then provided to the ADIRUHSS Dwelling Information Selection component 148, which selects and generates information specific to the identified dwellings to include as part of a search results response with target dwelling information 195, such as to filter and/or rank the identified dwellings (e.g., based on the relevance ratings), to select types of information to include for each dwelling, to format the search results in a particular manner (e.g., in a list format or overlaid on a map), etc. After the query response 195 with the dwelling information is generated by the component 148, or if the component 143 instead generates a clarifying query response 193 without forwarding the query segments 153 to the component 144, the generated query response 195 or 193 is provided via the GUI 119 to the client computing device of the user who submitted the query, such as for display on the client computing device as part of the GUI.

The same user may then provide one or more subsequent queries 191 to the GUI 119 as part of an ongoing search interaction session, such as with similar processing performed for the subsequent user queries, and optionally with the context of prior interactions during the session being maintained and used by the ADIRUHSS system (e.g., stored and used to add missing information in later queries, such as dwelling type or geographical area; stored and used to personalize query vector embeddings generated for such subsequent queries, etc.). In addition, a user may in some embodiments and situations provide optional user feedback 154, such as to indicate that incorrect search criteria have been determined for the user query, to otherwise provide feedback regarding accuracy of search results response 195 or to provide further clarifying information in response to a clarifying query response 193, to specify further user preferences to be used, etc. If so, such optional user feedback 154 may be forwarded to the components 142 and/or 143 and/or 144 and/or 146 and/or 148, such as to improve future determinations performed by the components. In other embodiments and situations, some or all such feedback may instead be implicit feedback that is determined based on an analysis of subsequent user queries (e.g., to indicate that a prior query response did not provide information that the user was seeking) and/or of prior user queries (e.g., to determine user preferences and/or user location, such as based on patterns in the prior user queries). While the example discussed above involves a single user performing multiple interactions with the ADIRUHSS system as part of an interaction session (e.g., spanning seconds, minutes, hours, days, etc.), it will be appreciated that the ADIRUHSS system may in at least some embodiments and situations be concurrently interacting with many users using different client computing devices, such as to maintain a separate GUI and interaction session history for each such user, and that a new interaction session may be initiated for a user after one or more prior interaction sessions with that user in various manners (e.g., based on a corresponding user instruction, such as to reflect a change in the types of dwelling information of interest; as determined automatically by the ADIRUHSS system, such as to reflect a change in the types of dwelling information being requested, or due to a defined period of time since a last user interaction being exceeded, such as one or more days; etc.).

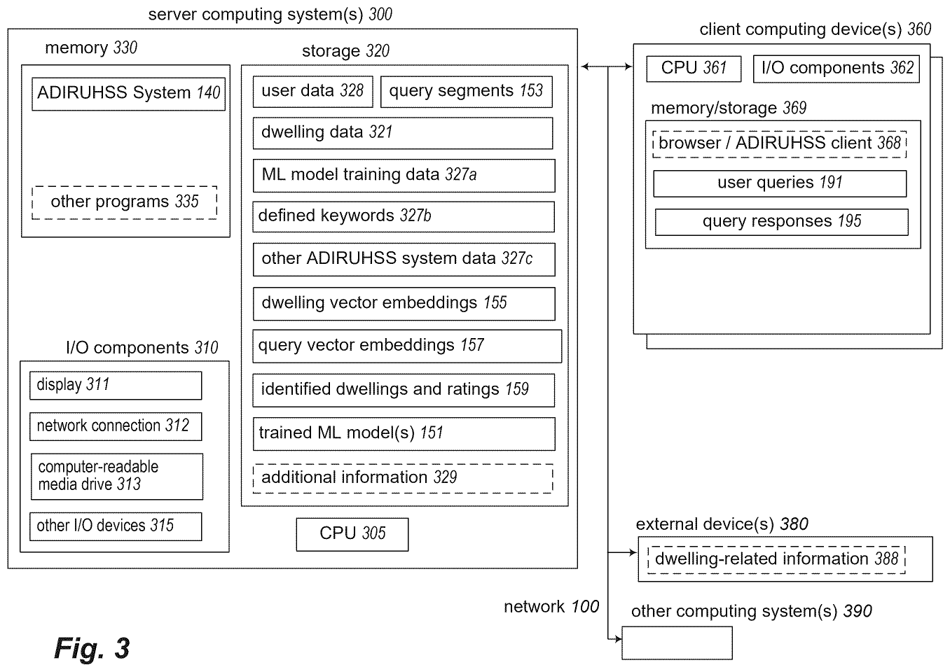

In addition, the computing system(s) 300 may include various other components and functionality, as discussed in greater detail elsewhere herein, including with respect to FIG. 3. The computer networks 100 may similarly be of various types in various embodiments and may include various types of wired and/or wireless segments, including one or more publicly accessible linked networks (e.g., operated by various distinct parties, such as the Internet) and/or a private network (e.g., a corporate or university network that is wholly or partially inaccessible to non-privileged users), including in some cases to have both private and public networks (e.g., with one or more of the private networks having access to and/or from one or more of the public networks).

FIG. 1B continues the example of FIG. 1A, and illustrates information 105b for one example embodiment of the ADIRUHSS Candidate Dwelling Evaluator/Selector component 146 discussed in FIG. 1A. In particular, the component 146 performs various activities in the illustrated embodiment to receive query segments 153 for the user query 191, a query segment vector embedding 157 for the query, and dwelling vector embeddings 155 for candidate dwellings, along with user data 328, dwelling data 321 and ADIRUHSS system data 327, and to identify one or more candidate dwellings that satisfy the search criteria of the user query.

In operation, the component 146 receives as input the query segments 153 for the user query 191, a query vector embedding 157 for the query, and dwelling vector embeddings 155 for candidate dwellings. In block 162, the component then determines any dwelling type(s) and geographical area(s) specified in the query or otherwise associated with the user who submitted the query, and restricts the candidate dwelling data for the current query to the determined dwelling type(s) and geographical area(s), if any, or otherwise selects all dwellings as candidate dwellings. In block 164, the component then selects one or more keyword-based query segments, extracts the keyword and optionally one or more associated values for each segment, searches the textual descriptions of candidate dwellings to identify dwellings having keyword-value pairs that match the extracted keywords and any associated values for all of the keyword-based query segments, and adds the identified dwellings to a group of first dwellings that are options for target dwellings to match all of the search criteria for the received user query. In block 166, the component then selects one or more non-keyword-based query segments, determines a phrase with multiple terms for each segment, optionally determines one or more alternative phrases using synonyms and/or stemming and/or lemmatization, searches the textual narrative descriptions of candidate dwellings to identify any dwellings having phrases that match the determined phrase or one of the determined alternative phrases for all of the non-keyword-based query segments, and adds the identified dwellings to a group of second dwellings that are options for target dwellings to match all of the search criteria for the received user query. In block 168, the component then determines similarities between the query vector embedding and the dwelling vector embeddings for the candidate dwellings to identify dwellings whose vector embeddings are within a similarity threshold to the query vector embedding (e.g., have a measured distance between the vector embeddings below a distance-based threshold), and adds the identified dwellings to a group of third dwellings that are options for target dwellings to match all of the search criteria for the received user query.

In block 170, the component then selects some or all of the first, second and third dwellings as being target dwellings that are identified to match the user query, optionally with associated relevance ratings or other weightings (e.g., based on measured similarities for third dwelling matches and/or other degrees of matching for first and/or second dwelling matches)—in at least some embodiments and situations, the selected dwellings may include those present in all of the first, second and third dwelling groups (e.g., an intersection), while in other embodiments and situations may include other dwellings, such as those present in at least the first and third dwelling groups. The selected target dwellings and any associated relevance ratings from block 170 are then provided as output in block 159.

FIG. 1C illustrates examples of non-exclusive types of building description information 105c that may be available in some embodiments for an example dwelling that in this case is a house, such as existing building information that is subsequently analyzed and used by the ADIRUHSS system. In the example of FIG. 1C, the building description information 105c includes an overview textual narrative description 105c1, and well as various keyword attribute data 105c2, such as may be used in part or in whole as listing information for an MLS system. In this example, the attribute data is grouped into sections (e.g., overview attributes, further interior detail attributes, further property detail attributes, etc.), with most of the attribute data specified using keyword-value pairs each having a keyword and at least one corresponding value (although other attributes may be specified using a keyword without any associated values, such as based on the presence or absence of the keyword, such as “deck” or “pool”), but in other embodiments the attribute data may not be grouped or may be grouped in other manners and may be specified in other manners, including for the building description information to not be separated into a list of attributes and a separate overview textual narrative description. In this example, the separate overview textual narrative description emphasizes characteristics that may be of interest to viewers, such as a house style type, information of interest about rooms and other building characteristics (e.g., have been recently updated or have other characteristics of interest), information of interest about the property and surrounding neighborhood or other environment, etc. In addition, in this example, the attribute data includes objective attributes of a variety of types about rooms and the building and limited information about appliances, but may lack details of various types shown in italics in this example (e.g., about subjective attributes, about inter-room connectivity and other adjacency, about other particular structural elements or objects and about attributes of such objects, etc.), such as may instead be determined by the ADIRUHSS system via analysis of building images and/or other building information (e.g., floor plans).

It will be appreciated that various details are provided with respect to FIGS. 1A-1C for illustrative purposes, and are not intended to limit the scope of the invention unless otherwise indicated. Similarly, additional exemplary details are provided with respect to FIGS. 2A-2E and elsewhere herein, and such details are similarly provided for illustrative purposes and are not intended to limit the scope of the invention unless otherwise indicated.

FIGS. 2A-2E illustrate examples of performing described techniques, including automatically responding to a free-form natural language search request for information about dwellings by using heterogeneous search strategies.

In particular, FIG. 2A illustrates information 205a including an example client computing device 360 (in this example, a smartphone) that is being used by a user (not shown) to interact with a GUI provided by the ADIRUHSS system, with current information 206 displayed in the GUI. In this example, an initial greeting screen is shown that includes a user selectable control 210a via which a user may sign in, as well as instructions regarding how to supply queries via the GUI. In this example, the user begins by entering an initial query 215a that includes a sequence of 9 natural language free-form terms of “homes near Discovery Park with 3+ bedrooms 2 bathrooms”, and the ADIRUHSS system has provided corresponding response information 220a, as well as an indication of the system's interpretation 217a of the natural language free-form terms along with a user-selectable control 218a for the user to indicate if the interpretation is incorrect. In this example, the terms “Discovery Park” are interpreted as a POI location corresponding to a park in Seattle, Washington, the term “homes” is interpreted as a dwelling type indicator, the term “near” is interpreted as an indeterminate distance associated with the POI location, the term “3+ bedrooms” is interpreted as a first keyword-based segment (with a keyword of “bedrooms” and associated value(s) of 3 or more), and the term “2 bathrooms” is interpreted as a second keyword-based segment (with a keyword of “bathrooms” and associated value of 2). In this example, a determined POI-specific nearby geographical region for the POI location extends around the shape of the park and is used to constrain the candidate dwellings to consider, as discussed further with respect to FIG. 2B. In this example, the matching home dwellings identified for the search query are shown in list format, with several types of identified information included for each search result, such as number of bedrooms, number of bathrooms, number of square feet of the dwelling, associated price, etc., as well as an address that is a user-selectable control with which the user can select to obtain further information specific to a particular dwelling. In this example, one or more keyword-based searches are performed based on the search criteria in the query, using the first and second keyword-based segments, and each of the listed dwellings includes 3 or more bedrooms and 2 bathrooms.

FIG. 2A further illustrates a second search query 215b that is similar to search query 215a, but in which additional search criteria are specified using additional natural language free-form terms to indicate a phrase-based segment of “large fenced yard” for the matching candidate dwellings. In response, the ADIRUHSS system generates and provides response information 220b that differs relative to information 220a by removing results 1, 3 and 4 in response 220a that do not meet the additional specified search criteria, while adding additional results that do match the additional search criteria and are within the POI-specific nearby geographical region for the Discovery Park POI location as well as match the keyword-based search criteria. In particular, one or more keyword-based searches are performed based on the search criteria in the query, using the first and second keyword-based segments, and a vector embedding-based search is also performed (with the query embedding vector, not shown, based on at least the phrase “large fenced yard”, and in some embodiments based on the entire query of “homes near Discovery Park with 3+ bedrooms 2 bathrooms with large fenced yard”), and a phrase-based search may optionally also be performed using the “large fenced yard” phrase for the corresponding non-keyword-based segment. Using the example textual description information of FIG. 1C as an example, the bedrooms and bathrooms keyword-value pairs in information 105c2 match the two keyword-based segments in the query, and the dwelling further satisfies the other predefined types of segments of “homes near Discovery Park”—while the text of “large, fully fenced backyard” in the textual narrative description 105c1 might not satisfy an exact or near-exact match to the phrase-based segment of “large fenced yard”, the query vector embedding for the query (not shown) and the dwelling vector embedding for this dwelling (not shown) will be very similar due to semantic content of the phrase-based segment being almost identical in meaning to the indicated text in the textual narrative description 105c1, with this house identified using such a vector embedding-based search. A similar vector embedding-based search may be performed for query 215a using the entire query, but a phrase-based search is not performed for it since it lacked a phrase-based segment that did not include a keyword or one of the other predefined types (in this case, a dwelling type indicator of “homes” and a POI location of “Discovery Park” and an indeterminate distance indicator of “near”).

FIG. 2B continues the example of FIG. 2A, and illustrates information 205b showing an alternative response to search query 215b, in which the search response information 220c in FIG. 2B is provided in the form of a map that includes a visual indicator 219 of the POI-specific geographical search region used for the Discovery Park POI location, and with the search results shown as visual indicators 221 overlaid on the map for each candidate dwelling that in this example are user-selectable controls with which the user can select to obtain more information about a respective dwelling. It will be appreciated that in this example the POI-specific nearby geographical region for the Discovery Park POI location has a shape that is nonuniform but that is roughly based on the shape of the POI location itself, although with different distances from the boundary of the park being used in different spots (e.g., based on one or more associated attributes for that POI location and/or for the dwellings, such as to include dwellings from which the park can be reached within a defined amount of time, etc.), while in other embodiments the geographical region may be determined in other manners (e.g., a uniform geometrical shape; the same shape as the POI location but larger on some or all sides; such as all sides with land and/or dwellings; etc.). FIG. 2B further indicates 210b that a particular user has signed-in, such that user-specific information may be used in various manners as discussed in greater detail elsewhere herein.

FIG. 2C continues the examples of FIGS. 2A-2B, and illustrates information 205c showing additional example search queries and associated responses by the ADIRUHSS system, such as alternative starting queries that could be used instead of search query 215b. In this example, the additional search queries include search query 215c, in which a dwelling type of apartments is indicated and in which the phrase-based segment of “large fenced yard” in query 215b is replaced with multiple phrases of “deck” and “views of Puget Sound”, and in which the keyword-based segment for number of bedrooms is removed, and with corresponding response information 220d shown. Thus, in this example, only a single keyword-based segment may be identified and used, while the vector embedding generated for the query 215c will be based at least in part on “deck and views of Puget Sound” and in some embodiments and situations on the entire query. The additional search queries further include search query 215d, which is somewhat similar to search query 215b, but in which the phrase-based query segment(s) include an indication of dwelling style (“mid-century modern or rambler”), an expanded phrase of “large fenced yard for dogs”, and additional phrase-based criteria that include “near transit” and “with an outdoor built-in barbecue”, and in which the keyword-based segment for number of bathrooms is removed, and with corresponding response information 220e shown. Thus, in this example, only a single keyword-based segment may be identified and used, while the vector embedding generated for the query 215d will be based at least in part on “mid-century modern or rambler and large fenced yard for dogs and near transit and with an outdoor built-in barbecue” and in some embodiments and situations on the entire query.

FIG. 2D continues the examples of FIGS. 2A-2C, and illustrates information 205d showing the use of the ADIRUHSS Dwelling Vector Embedding Encoder component 142 to use one or more trained ML models (not shown) to generate various dwelling vector embeddings 155 from corresponding dwelling textual description information 106d. In this example, textual description information 106d1 is shown for an example dwelling 1, which includes an overview textual narrative 106c1, keyword attributes 106c2, and optionally other textual information for the dwelling 106c3 (e.g., from one or more external sources), with that textual description information 106d1 used to generate a corresponding dwelling one vector embedding 155d1. In a similar manner, textual description information 106d2, 106d3 and 106d4 through 106dN for respective dwellings 2, 3 and 4 through N are illustrated and used by the component 142 to generate corresponding dwelling vector embeddings 155d2, 155d3, 155d4 and 155dN. Additional details are included elsewhere herein regarding the generation of the dwelling vector embeddings.

FIG. 2E continues the examples of FIGS. 2A-2D, and illustrates information 205e showing architectural details for the ADIRUHSS Candidate Dwelling Evaluator/Selector component 146 in using heterogeneous search strategies to determine target dwellings that match a specified user query. In particular, in this example, a dwelling vector embedding database 271c is shown that includes the dwelling vector embeddings 155d illustrated in FIG. 2D, with those floor vector embeddings provided to an ADIRUHSS Candidate Dwelling Evaluator/Selector embedding comparator component 146c along with a query vector embedding 157, with the component 146c determining inter-embedding distances and using those determined distances to identify one or more best match vector embedding-based results 290c (e.g., a best result, all results that are below a determined distance threshold, a top N results, etc.). In addition, an ADIRUHSS Candidate Dwelling Evaluator/Selector phrase comparator component 146b receives information from a dwelling textual narrative database 271b that includes textual narrative descriptions (not shown) of various candidate dwellings, and compares them to one or more additional non-keyword phrase-based query segments 153b that include one or more phrases (not shown), in order to identify one or more best match phrase-based results 290b (e.g., using an exact or near-exact matching strategy, and such as to identify a best result; all results that match within a defined degree of similarity, such as an exact match to the original phrase or an exact match to one or more alternative phrases based on the original phrase; a top N results; etc.). An ADIRUHSS Candidate Dwelling Evaluator/Selector keyword comparator component 146a is further illustrated that receives information from a dwelling keyword attribute database 271a that includes textual keyword-value pairs (not shown) of various candidate dwellings, and compares them to one or more keyword-based query segments 153a that include one or more keywords with optional associated values (not shown), in order to identify one or more best match keyword-based results 290a (e.g., to identify a best result, all results that match, a top N results, etc.). An illustrated ADIRUHSS Candidate Dwelling Evaluator/Selector dwelling selector and ranker component 146d is further illustrated that takes as input the keyword-based results 290a, the phrase-based results 290b and the vector embedding-based results 290c, and compares the results to identify one or more target dwellings 159 with optional relevance ratings. As discussed in greater detail elsewhere, in some embodiments a particular search query may not include all of the illustrated types of information, such as to include only one of the keyword-based query segment(s) 153a and additional non-keyword search criteria query segment(s) 153b.

It will be appreciated that the examples of FIGS. 2A-2E are provided for illustrative reasons only, and are not intended to limit the scope of the invention. For example, a variety of other combinations of natural language free-form search terms may be used in other embodiments and situations.

For illustrative purposes, some embodiments are described herein in which specific types of information are acquired, used and/or presented in specific ways using specific types of data structures and by using specific types of devices-however, it will be understood that the described techniques may be used in other manners in other embodiments, and that the invention is not limited to exemplary details provided. As one non-exclusive example, specific types of data structures and algorithms are generated and/or used in specific manners in some embodiments, but it will be appreciated that other types of information may be generated and used in other manners in other embodiments, including for types of information other than dwelling information. Similarly, while particular user interface display and interaction techniques are shown, other user interaction techniques may be used in other embodiments. In addition, various details are provided in the drawings and text for exemplary purposes, but are not intended to limit the scope of the invention—for example, sizes and relative positions of elements in the drawings are not necessarily drawn to scale, with some details omitted and/or provided with greater prominence (e.g., via size and positioning) to enhance legibility and/or clarity, and identical reference numbers may be used in the drawings to identify the same or similar elements or acts.

FIG. 3 is a block diagram illustrating an embodiment of one or more server computing systems 300 executing an implementation of an ADIRUHSS system 140, such as in a manner similar to that of FIGS. 1A-1C and with additional hardware details illustrated—the server computing system(s) and ADIRUHSS system may be implemented using a plurality of hardware components that form electronic circuits suitable for and configured to, when in combined operation, perform at least some of the techniques described herein. In the illustrated embodiment, each server computing system 300 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.).

The server computing system(s) 300 and executing ADIRUHSS system 140 may communicate with other computing systems and devices via one or more networks 100 (e.g., the Internet, one or more cellular telephone networks, etc.), such as user client computing devices 360 (e.g., used to supply queries; receive responsive answers; and use the received answer information, such as to display or otherwise present answer information to users of the client computing devices and/or to implement further automated activities, such as to access other functionality provided by the ADIRUHSS system), optionally other external devices 380 (e.g., used to store and provide dwelling information of one or more types), and optionally other computing systems 390.

In the illustrated embodiment, an embodiment of the ADIRUHSS system 140 executes in memory 330 in order to perform at least some of the described techniques, such as by using the processor(s) 305 to execute software instructions of the system 140 in a manner that configures the processor(s) 305 and computing system 300 to perform automated operations that implement those described techniques. The illustrated embodiment of the ADIRUHSS system may include one or more components, not shown, to each perform portions of the functionality of the ADIRUHSS system, and the memory may further optionally execute one or more other programs 335. The ADIRUHSS system 140 may further, during its operation, store and/or retrieve various types of data on storage 320 (e.g., in one or more databases or other data structures), such as various types of user data 328, dwelling data 321 (e.g., textual dwelling description data), ML model training data 327a, defined keyword data 327b, other ADIRUHSS system data 327c, dwelling vector embeddings 155, query vector embeddings 157, identified target dwellings and optionally associated ratings 159, trained ML model(s) 151, and/or various other types of optional additional information 329.

Some or all of the user client computing devices 360 (e.g., mobile devices), external devices 380, and other computing systems 390 may similarly include some or all of the same types of components illustrated for server computing system 300. As one non-limiting example, the computing devices 360 are each shown to include one or more hardware CPU(s) 361, I/O components 362, and memory and/or storage 369, with a browser and/or ADIRUHSS client program 368 optionally executing in memory to interact with the ADIRUHSS system 140 and present or otherwise use query responses 195 that are received from the ADIRUHSS system for submitted user queries 191. While particular components are not illustrated for the other devices/systems 380 and 390, it will be appreciated that they may include similar and/or additional components.

It will also be appreciated that computing system 300 and the other systems and devices included within FIG. 3 are merely illustrative and are not intended to limit the scope of the present invention. The systems and/or devices may instead each include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, and various other consumer products that include appropriate communication capabilities. In addition, the functionality provided by the illustrated ADIRUHSS system 140 may in some embodiments be distributed in various components, some of the described functionality of the ADIRUHSS system 140 may not be provided, and/or other additional functionality may be provided.

It will also be appreciated that, while various items are illustrated as being stored in memory or on storage while being used, these items or portions of them may be transferred between memory and other storage devices, such as for purposes of execution, memory management, data integrity, etc. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the ADIRUHSS system 140 executing on server computing systems 300) and/or data structures, such as by execution of software instructions of the one or more software programs and/or by storage of such software instructions and/or data structures, and such as to perform algorithms as described in the flow charts and other disclosure herein. Furthermore, in some embodiments, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

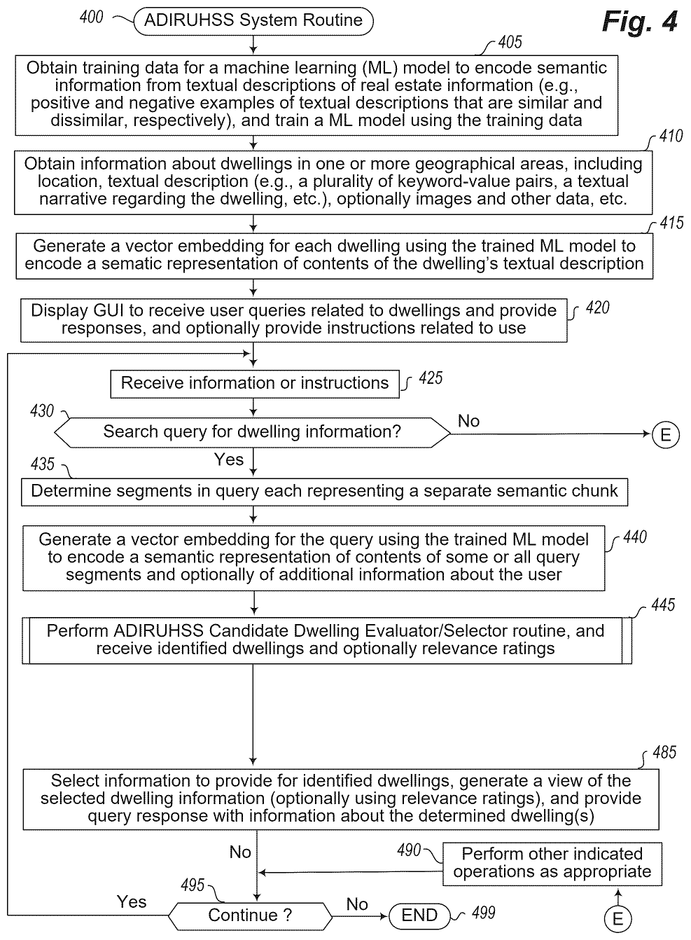

FIG. 4 is a flow diagram of an example embodiment of an ADIRUHSS system routine 400. The routine may be provided by, for example, execution of the ADIRUHSS system 140 of FIGS. 1A-1C, and/or the ADIRUHSS system 140 of FIG. 3, and/or corresponding functionality discussed with respect to FIGS. 2A-2E and elsewhere herein, such as to perform automated operations related to automatically responding to a free-form natural language request for information about dwellings by using heterogeneous search strategies to determine corresponding matching target dwellings. In the illustrated embodiment, the routine interacts with a single user at a time to provide dwelling response information to search queries from that user, but it will be appreciated that the routine may interact in a similar manner with multiple users (e.g., sequentially or concurrently), and that the routine may in other embodiments perform similar types of activities for other types of information.

In the illustrated embodiment, the routine 400 begins at 405, where it obtains training data for a machine learning (ML) model to encode semantic information of textual descriptions for real estate-related information, such as positive and negative examples of textual descriptions that are similar and dissimilar, respectively, and trains a ML model using the training data. In block 410, the routine then obtains information about dwellings in one or more geographical areas, such as location, a textual description (e.g., a plurality of keyword-value pairs, a textual narrative regarding the dwelling, etc.), optionally images and other data, etc. In block 415, the routine then generates a vector embedding for each dwelling using a trained ML model, to encode the semantic representation of contents of the dwelling's textual description. In block 420, the routine then displays a GUI to receive user queries related dwellings and to provide corresponding responses, as well as to optionally provide instructions related to its use.

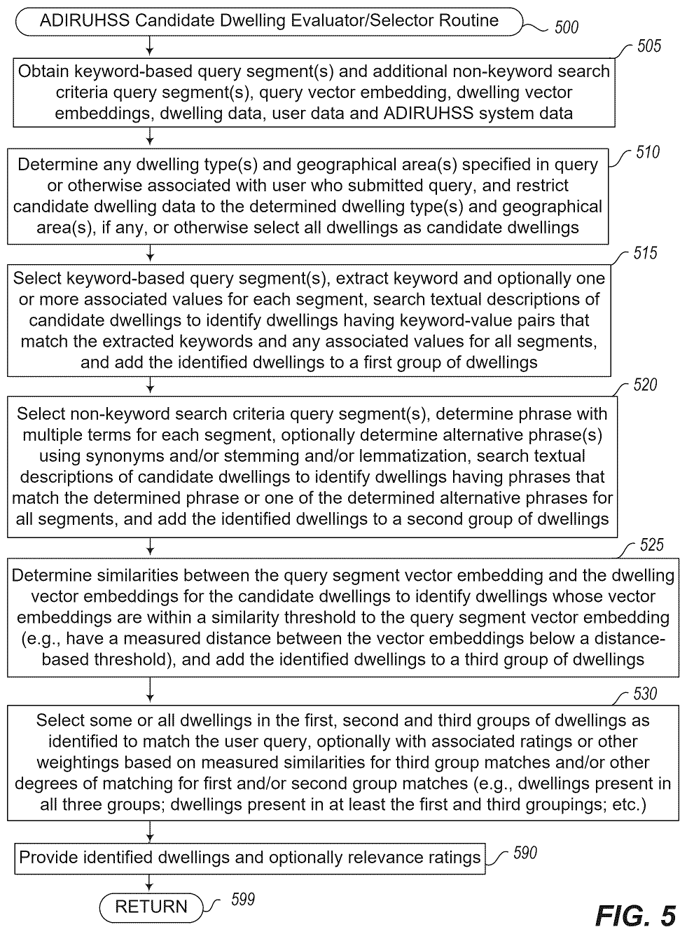

The routine then proceeds to perform blocks 425-490 to receive and respond to user-provided search queries and optionally other types of instructions and information. In particular, the routine in block 425 waits to receive instructions or other information, and after receiving such instructions or other information, proceeds to block 430 to determine whether the instructions or other information received in block 425 include a search query for dwelling information. If not, the routine continues to block 490, and otherwise continues to block 435 to determine one or more segments in the search query that each represents a separate semantic chunk and correspond to associated search criteria. In block 440, the routine then generates a vector embedding for the query using the trained ML model to encode us Mac representation of contents of some or all of the query and optionally of additional information about the user. In block 445, the routine then proceeds to perform the ADIRUHSS Candidate Dwelling Evaluator/Selector routine, and to receive identified target dwellings and optionally relevance ratings-FIG. 5 illustrates one example of such a routine. In block 485, the routine then selects information to provide for some or all of the identified target dwellings, generates a view of the selected dwelling information (optionally using that relevance ratings), and provides a query response with information about the determined dwellings using the generated view.

If it is instead determined in block 430 that the received instructions or other information is not a search query for dwelling information, the routine in block 490 proceeds to perform one or more other indicated operations as appropriate, with non-exclusive examples of such other operations including retrieving and providing previously determined or generated information (e.g., previous user queries, previously determined responses to user queries, etc.), receiving and storing information for later use (e.g., information about dwelling data 321, user data 328, ADIRUHSS system data 327, etc.), responding to other types of search queries (e.g., without any phrase-based segments, without any non-keyword-based segments, etc.), receiving and using feedback from a user in response to provided query responses in block 485, providing information about how one or more previous query responses were determined, performing housekeeping operations, etc.

After blocks 485 or 490, the routine continues to block 495 to determine whether to continue, such as until an explicit indication to terminate is received (or alternatively only if an explicit indication to continue is received). If it is determined to continue, the routine returns to block 425 to await further information or instructions from the same user (or alternatively to return to block 420 to begin interactions with a different user), and if not continues to block 499 and ends.

FIG. 5 is a flow diagram of an example embodiment of an ADIRUHSS Candidate Dwelling Evaluator/Selector routine 500. The routine may be provided by, for example, execution of the ADIRUHSS Candidate Dwelling Evaluator/Selector component 146 of FIGS. 1A-1C and/or a corresponding component (not shown) of the ADIRUHSS system 140 of FIG. 3 and/or with respect to corresponding functionality discussed with respect to FIGS. 2A-2E and elsewhere herein, such as to receive a user query and information generated from it, and to identify target dwellings that match the search criteria using heterogeneous search strategies. In addition, in at least some situations, the routine 500 may be performed based on execution of block 445 of FIG. 4, with resulting information provided and execution control returning to that location when the routine 500 ends—in other embodiments, the routine may be invoked in other manners. In this example, the routine 500 is performed using particular ways to identify and use multiple search strategies for different parts of a received search query, but in other embodiments may use other techniques to use multiple search strategies, whether in addition to or instead of the illustrated types of techniques.

The illustrated embodiment of the routine 500 begins at block 505, where it obtains one or more keyword-based query segments and additional non-keyword-based query segments for a user query, as well as a corresponding query vector embedding, dwelling vector embeddings for various candidate dwellings, associated dwelling data for the candidate dwellings, user data for at least a user who submitted the query, and other ADIRUHSS system data. In block 510, the routine then determines any dwelling type(s) and geographical area(s) specified in the query or otherwise associated with the user who submitted the query, and restricts the candidate dwelling data for the current query to the determined dwelling type(s) and geographical area(s), if any, or otherwise selects all dwellings as candidate dwellings. In block 515, the routine then selects one or more keyword-based query segments, extracts the keyword and optionally one or more associated values for each segment, searches the textual descriptions of candidate dwellings to identify dwellings having keyword-value pairs that match the extracted keywords and any associated values for all of the keyword-based query segments, and adds the identified dwellings to a group of first dwellings that are options for target dwellings to match all of the search criteria for the received user query. In block 520, the routine then selects one or more non-keyword-based query segments, determines a phrase with multiple terms for each segment, optionally determines one or more alternative phrases using synonyms and/or stemming and/or lemmatization, searches the textual narrative descriptions of candidate dwellings to identify any dwellings having phrases that match the determined phrase or one of the determined alternative phrases for all of the non-keyword-based query segments, and adds the identified dwellings to a group of second dwellings that are options for target dwellings to match all of the search criteria for the received user query. In block 525, the routine then determines similarities between the query vector embedding and the dwelling vector embeddings for the candidate dwellings to identify dwellings whose vector embeddings are within a similarity threshold to the query vector embedding (e.g., have a measured distance between the vector embeddings below a distance-based threshold), and adds the identified dwellings to a group of third dwellings that are options for target dwellings to match all of the search criteria for the received user query. In block 530, the routine then selects some or all of the first, second and third dwellings as being target dwellings that are identified to match the user query, optionally with associated relevance ratings or other weightings (e.g., based on measured similarities for third dwelling matches and/or other degrees of matching for first and/or second dwelling matches)—in at least some embodiments and situations, the selected dwellings may include those present in all of the first, second and third dwelling groups (e.g., an intersection), while in other embodiments and situations may include other dwellings, such as those present in at least the first and third dwelling groups. The selected target dwellings and any associated relevance ratings are then provided as output in block 590, and the routine then continues to block 599 and returns, such as to return to the flow of FIG. 4 at block 445 if invoked from there.

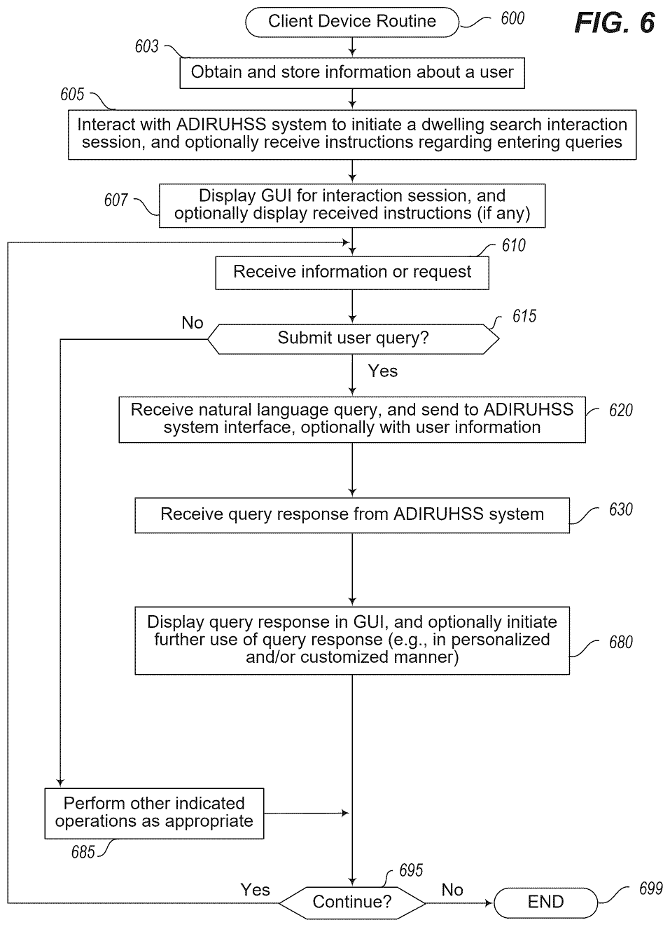

FIG. 6 is a flow diagram of an example embodiment of a client device routine 600. The routine may be provided by, for example, operations of a client computing device 360 of FIGS. 1A-1C and/or a client computing device 360 of FIG. 3 and/or with respect to corresponding functionality discussed with respect to FIGS. 2A-2E and elsewhere herein, such as to interact with users or other entities who submit queries (or other information) to the ADIRUHSS system, to receive responsive answers (or other information) from the ADIRUHSS system, and to optionally use the received information in one or more manners (e.g., to automatically initiate follow-up activities in accordance with a received responsive answer).

The illustrated embodiment of the routine 600 begins at block 603, where information is optionally obtained and stored about the user, such as for later use in personalizing or otherwise customizing further actions to that user. The routine then continues to block 605 to interact with the ADIRUHSS system to initiate an interaction session (e.g., in response to a corresponding instruction from the user), as well as to optionally receive a greeting and/or introductory instructions regarding using a GUI of the ADIRUHSS system. In block 607, the routine then displays a GUI for the interaction session, and optionally displays the received greeting and/or introductory instructions, if any. The routine then continues to perform blocks 610-680 as part of participating in the interaction session.

In particular, the routine continues to block 610 after block 607, where it waits until information or a request is received from the user. In block 615, the routine determines if the information or request received in block 610 is a search query to submit, such as in a natural language format (e.g., freeform text), and if not continues to block 685. Otherwise, the routine continues to block 620, where it sends the received query to the ADIRUHSS system interface, optionally along with additional information about the user from block 603, to obtain a corresponding responsive answer in block 630—in other embodiments, the routine may further modify the received user query to personalize and/or customize the information to be provided to the ADIRUHSS system (e.g., to add information specific to the user, such as location, demographic information, preference information, etc.). In block 680, the routine then displays the received query response in the GUI, and optionally initiates further use of the query response in one or more manners (e.g., in a manner that is personalized and/or customized for the user)—in some embodiments, the further initiated activities may include invoking of other functionality of the ADIRUHSS system, such as to initiate an inspection process for a selected dwelling indicated in dwelling information search results, to initiate a mortgage application process for a selected dwelling indicated in dwelling information search results, to initiate matching the user with a real estate professional as part of a housing search based on corresponding response information received from the ADIRUHSS system, etc.

In block 685, the routine instead performs one or more indicated operations as appropriate other than receiving and submitting a query, with non-exclusive examples including sending information to the ADIRUHSS system of other types, receiving and storing user data for later use in personalization and/or customization activities, receiving and responding to requests for information about previous user queries and/or corresponding responsive answers for a current user and/or client device, receiving and responding to indications of one or more housekeeping activities to perform, etc. After blocks 680 or 685, the routine continues to block 695 to determine whether to continue, such as until an explicit indication to terminate is received (or alternatively only if an explicit indication to continue is received). If it is determined to continue, the routine returns to block 610, and if not continues to block 699 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the claims that are specified and the elements recited therein. In addition, while certain aspects of the invention may be presented at times in certain claim forms, the inventors contemplate the various aspects of the invention in any available claim form. For example, while only some aspects of the invention may be recited at a particular time as being embodied in a computer-readable medium, other aspects may likewise be so embodied.

What is claimed is:

1. A computer-implemented method comprising:
training, by one or more computing devices, a machine learning model trained to capture semantic relationships between words, including using positive examples each having two or more first real estate phrases that are semantically similar and using negative examples each having two or more second real estate phrases that are not semantically similar;
generating, by the one or more computing devices and using the trained machine learning model, and for a plurality of dwellings in a geographical area that each has an associated textual description including a plurality of keyword-value pairs and further including a textual narrative describing that dwelling using freeform text, respective vector-based embeddings for the plurality of dwellings that each encodes a semantic representation of contents of the associated textual description for one of the plurality of dwellings;
receiving, by the one or more computing devices and after the generating of the respective vector-based embeddings for the plurality of dwellings, a user query for information about target dwellings in the geographical area that satisfy multiple specified search criteria, the multiple search criteria being specified using a sequence of freeform terms submitted via a natural language interface;
separating, by the one or more computing devices, the sequence of the freeform terms into multiple segments each having one or more of the terms, the multiple segments including one or more first segments each having a keyword from a plurality of predefined keywords and one or more associated values for the keyword, and including a second segment having multiple terms that lack any of the plurality of predefined keywords;
generating, by the one or more computing devices, an additional vector embedding for the user query that encodes an additional semantic representation of the multiple segment;
determining, by the one or more computing devices, one or more first dwellings matching the one or more first segments by, for each of the one or more first dwellings and each of the first segments, including a keyword-value pair in the plurality of keyword-value pairs in the textual description for that first dwelling having the keyword for that first segment and having a corresponding value that matches the one or more associated values for that keyword in that first segment;
determining, by the one or more computing devices, one or more second dwellings matching the second segment by, for each of the one or more second dwellings, having a phrase in the textual narrative of the textual description for that second dwelling that matches the multiple terms in the second segment;
determining, by the one or more computing devices, one or more third dwellings whose respective vector-based embeddings differ from the additional vector embedding for the user query by at most a defined threshold amount;
determining, by the one or more computing devices, at least one target dwelling of the plurality of dwellings that satisfies the multiple search criteria, including identifying that the at least one target dwelling is part of each of the one or more first dwellings and the one or more second dwellings and the one or more third dwellings; and
presenting, by the one or more computing devices and in a displayed graphical user interface, information about the determined at least one target dwelling as part of response information to the user query.

2. The computer-implemented method of claim 1 wherein the phrase for each of the one or more second dwellings includes a sequence of additional terms, wherein the determining of the one or more second dwellings matching the second segment includes determining, for each of the one or more second dwellings, that each of the additional terms in the phrase for that second dwelling matches one of the multiple terms of the second segment using one of an exact match to the one term or an exact match to one or more defined synonyms for the one term or an approximate match to a version of the one term generated using at least one of stemming or lemmatization, and wherein the determining that the respective vector-based embeddings of the one or more third dwellings differ from the additional vector embedding for the user query by at most the defined threshold amount includes measuring, for each of the respective vector-based embeddings of the one or more third dwellings, a distance between the additional vector embedding and that respective vector-based embedding, and determining that the measured distance is below a distance-based threshold.

3. The computer-implemented method of claim 1 wherein the multiple search criteria indicate a type of dwelling, at least one geographical location in the geographical area, and multiple dwelling characteristics.

4. A computer-implemented method comprising:
generating, by one or more computing devices and for a plurality of dwellings in one or more geographical areas, respective vector-based embeddings for the plurality of dwellings that each encodes a semantic representation of contents of a textual description of an associated one of the plurality of dwellings;
receiving, by the one or more computing devices and after the generating of the respective vector-based embeddings for the plurality of dwellings, a user query for information about target dwellings that are in at least one of the one or more geographical areas and that satisfy multiple specified search criteria, the multiple search criteria being specified using a sequence of freeform terms submitted via a natural language interface;
separating, by the one or more computing devices, the sequence of the freeform terms into multiple segments each having one or more of the terms, the multiple segments including a first segment having a keyword from a plurality of predefined keywords and one or more associated values for the keyword, and including a second segment lacking any of the plurality of predefined keywords;
generating, by the one or more computing devices, an additional vector embedding for the user query that encodes an additional semantic representation of at least the second segment;
determining, by the one or more computing devices, one or more first dwellings whose textual descriptions match the first segment by including, for each of the one or more first dwellings, a keyword-value pair in that textual description having the keyword for the first segment and having a corresponding value that matches the one or more associated values for the keyword in the first segment;
determining, by the one or more computing devices, one or more second dwellings whose respective vector-based embeddings differ from the additional vector embedding for the user query by at most a defined threshold amount;
determining, by the one or more computing devices, at least one target dwelling of the plurality of dwellings that satisfies the multiple search criteria, including identifying that the at least one target dwelling is part of both the one or more first dwellings and the one or more second dwellings; and
presenting, by the one or more computing devices, information about the determined at least one target dwelling as part of response information to the user query.

5. The computer-implemented method of claim 4 wherein the generating of the respective vector-based embeddings for the plurality of dwellings and the generating of the additional vector embedding for the user query includes using a machine learning model trained to capture semantic relationships between words, and wherein the determining that the respective vector-based embeddings of the one or more second dwellings differ from the additional vector embedding for the user query by at most the defined threshold amount includes measuring, for each of the respective vector-based embeddings of the one or more second dwellings, a distance between the additional vector embedding and that respective vector-based embedding, and determining that the measured distance is below a distance-based threshold.

6. The computer-implemented method of claim 5 further comprising, before the generating of the respective vector-based embeddings for the plurality of dwellings, training the machine learning model using positive examples each having two or more first real estate phrases that are semantically similar and using negative examples each having two or more second real estate phrases that are not semantically similar.

7. The computer-implemented method of claim 4 wherein the multiple segments further include multiple first segments each having a distinct keyword from the plurality of keywords and having one or more associated values for that distinct keyword, wherein the textual description of each of the plurality of dwellings includes a plurality of keyword-value pairs to describe attributes of that dwelling, and wherein the determining of the one or more first dwellings includes determining that the plurality of keyword-value pairs of the textual description for that first dwelling matches the distinct keyword and one or more associated values for each of the multiple first segments.

8. The computer-implemented method of claim 4 wherein the textual description of each of the plurality of dwellings further includes a textual narrative describing that dwelling using freeform text, and wherein the semantic representation encoded in the respective vector-based embedding for each of the plurality of dwellings is based at least in part on the textual narrative describing that dwelling.

9. The computer-implemented method of claim 4 wherein the multiple segments include one segment indicating a type of dwelling, one or more other segments identifying at least one geographical location, and one or more further segments indicating one or more characteristics of the target dwellings.

10. The computer-implemented method of claim 4 wherein the generating of the additional vector embedding for the user query includes generating a single additional vector embedding that encodes semantic information of all of the multiple segments.

11. The computer-implemented method of claim 4 wherein the generating of the respective vector-based embeddings for the plurality of dwellings includes, for each of the plurality of dwellings, further encoding a further semantic representation in the respective vector-based embedding for that dwelling of contents of additional information about that dwelling obtained from one or more public sources of data about dwellings.

12. The computer-implemented method of claim 4 wherein the generating of the additional vector embedding for the user query further includes obtaining additional information specific to a user that supplies the user query, and further encoding a further semantic representation in the additional vector embedding of contents of the additional information specific to the user.

13. The computer-implemented method of claim 4 wherein the user query is received from a client device, and wherein the presenting of the information about the determined at least one target dwelling includes transmitting, by the one or more computing devices, search results that include the information about the determined at least one target dwelling over one or more computer networks to the client device for display on the client device.

14. A system comprising:
one or more hardware processors of one or more computing devices; and
one or more memories with stored instructions that, when executed by at least one of the one or more hardware processors, cause at least one computing device of the one or more computing devices to perform automated operations including at least:
obtaining, for a plurality of dwellings, respective vector-based embeddings that each represents semantic content from a textual description of an associated one of the plurality of dwellings;
receiving a user query for information about target dwellings satisfying one or more search criteria that are specified at least in part using a sequence of freeform natural language terms;
generating an additional vector embedding for the user query that represents further semantic content of at least some of the user query;
determining at least one target dwelling of the plurality of dwellings that satisfies the one or more search criteria, including determining for each of the at least one target dwellings that the respective vector-based embedding for that target dwelling matches the additional vector embedding for the user query, and further including determining for each of the at least one target dwellings that the textual description for that target dwelling includes each of one or more terms included in the user query; and
providing information about the determined at least one target dwelling as part of response information to the user query.

15. The system of claim 14 wherein the user query specifies multiple search criteria using a sequence of multiple freeform terms, wherein the stored instructions include software instructions that, when executed by the one or more hardware processors, cause the one or more computing devices to perform further automated operations including separating the sequence of the multiple freeform terms into multiple segments each having one or more terms, the multiple segments including one or more first segments each having a keyword from a plurality of predefined keywords and one or more associated values, and further including one or more second segments lacking any of the predefined keywords, and wherein the determining that the textual description for a target dwelling includes each of one or more terms included in the user query includes determining that, for each of the one or more first segments, that textual description includes a keyword-value pair that matches the keyword and the one or more associated values for that first segment.

16. The system of claim 15 wherein the multiple segments include one segment indicating a type of dwelling, one or more other segments identifying at least one geographical location, and one or more further segments indicating one or more characteristics of the target dwellings, and wherein the generating of the additional vector embedding for the user query includes generating a single additional vector embedding that encodes semantic information of all of the multiple segments.

17. The system of claim 15 wherein the textual description for each of the plurality of dwellings includes a textual narrative describing that dwelling using freeform text and includes a plurality of keyword-value pairs, and wherein the automated operations further include, before the receiving of the user query, generating, for each of the plurality of dwellings, the respective vector-based embedding for that dwelling to encode a semantic representation of contents of at least the textual narrative and the plurality of keyword-value pairs included in the textual description of that dwelling.

18. The system of claim 17 wherein the automated operations further include training a machine learning model to capture semantic relationships between words using positive examples of two or more first real estate phrases that are semantically similar and using negative examples of two or more second real estate phrases that are not semantically similar, wherein the generating of the respective vector-based embeddings for the plurality of dwellings and the generating of the additional vector embedding for the user query includes using the trained machine learning model, and wherein the determining that a respective vector-based embedding for a target dwelling matches the additional vector embedding for the user query includes measuring a distance between that respective vector-based embedding for that target dwelling and the additional vector embedding, and determining that the measured distance is below a distance-based threshold.

19. The system of claim 14 wherein the determining that a respective vector-based embedding for a target dwelling matches the additional vector embedding for the user query includes determining that the respective vector-based embedding for the target dwelling differs from the additional vector embedding by at most a defined threshold amount, and wherein the providing of the information about the determined at least one target dwelling includes presenting the information about the determined at least one target dwelling in a displayed graphical user interface.

20. A non-transitory computer-readable medium having stored contents that cause one or more computing devices to perform automated operations, the automated operations including at least:
obtaining, by the one or more computing devices and for a plurality of buildings, respective vector-based embeddings for the plurality of buildings that each encodes semantic information from a textual description of an associated one of the plurality of buildings;
receiving, by the one or more computing devices, a user query for information about one or more target buildings satisfying multiple search criteria that are specified at least in part using a sequence of freeform natural language terms;
separating, by the one or more computing devices, the sequence of the freeform terms into multiple segments each having one or more of the terms, the multiple segments including a first segment having a keyword from a plurality of predefined keywords, and including a second segment lacking any of the plurality of predefined keywords;
generating, by the one or more computing devices, an additional vector embedding for the user query that encodes additional semantic information of at least the second segment;
determining, by the one or more computing devices, at least one target building of the plurality of buildings that satisfies the multiple search criteria, including determining for each of the at least one target buildings that the respective vector-based embedding for that target building matches the additional vector embedding for the user query, and further including determining for each of the at least one target buildings that the textual description for that target building includes the keyword in the first segment; and
providing, by the one or more computing devices, information about the determined at least one target building as part of response information to the user query.

21. The non-transitory computer-readable of claim 20 wherein the first segment further includes one or more values associated with the keyword, wherein the determining that the textual description for a target building includes the keyword further includes determining that the textual description has a corresponding value for the keyword matching at least one of the one or more associated values in the first segment, and wherein the providing of the information about the determined at least one target building includes presenting the information about the determined at least one target building in a displayed graphical user interface.

22. The non-transitory computer-readable of claim 20 wherein the textual description for each of the plurality of buildings includes a textual narrative describing that building using freeform text and includes a plurality of keyword-value pairs, wherein the stored contents include software instructions that, when executed by the one or more computing devices, cause the one or more computing devices to perform further automated operations including, before the receiving of the user query, generating, for each of the plurality of buildings, the respective vector-based embedding for that building to encode a semantic representation of contents of at least the textual narrative and the plurality of keyword-value pairs included in the textual description of that building, and wherein the determining that a respective vector-based embedding for a target building matches the additional vector embedding for the user query includes determining that the respective vector-based embedding for the target building differs from the additional vector embedding by at most a defined threshold amount.

23. The non-transitory computer-readable of claim 22 wherein the automated operations further include training a machine learning model to capture semantic relationships between words using positive examples of two or more first real estate phrases that are semantically similar and using negative examples of two or more second real estate phrases that are not semantically similar, wherein the generating of the respective vector-based embeddings for the plurality of buildings and the generating of the additional vector embedding for the user query includes using the trained machine learning model, and wherein the determining that a respective vector-based embedding for a target building differs from the additional vector embedding by at most the defined threshold amount includes measuring a distance between that respective vector-based embedding for that target building and the additional vector embedding, and determining that the measured distance is below a distance-based threshold.

24. The non-transitory computer-readable of claim 20 wherein the multiple segments include one segment indicating a type of building, one or more other segments identifying at least one geographical location, and one or more further segments indicating one or more characteristics of the target buildings, and wherein the generating of the additional vector embedding for the user query includes generating a single additional vector embedding that encodes semantic information of all of the multiple segments.
